(19) United States
(12) Patent Application Publication
(10) Pub. No.: US 2006/0291022 A1
(43) Pub. Date: Dec. 28, 2006

(54) Optical delay line in holographic drive

(75) Inventors: Ian R. Redmond, Boulder, CO (US); Larry Fabiny, Boulder, CO (US); Vladimir Krneta, Boulder, CO (US); Brian S. Riley, Firestone, CO (US)

Correspondence Address: JAGTIANI + GUTTAG, 10363-A DEMOCRACY LANE, FAIRFAX, VA, 22030, US

(73) Assignee: InPhase Technologies, Inc., Longmont, CO (US)

(21) Appl. No.: 11/440,358

(22) Filed: May 25, 2006

Related U.S. Application Data
(60) Provisional application No. 60/684,531, filed on May 26, 2005.

(51) Int. Cl. G02B 5/32

(52) U.S. Cl. 359/15

(57) ABSTRACT

The present invention relates to a system comprising a holographic data storage drive that records holographic digital data in a holographic recording medium, and which comprises: a data beam path having a first optical path length; and a reference beam path having a second optical path length; wherein one of the data beam and reference beams paths comprise an optical delay line so that the difference between the first and second optical path lengths is less than the laser coherence length. The present invention further relates to a method for operating a laser in the holographic data storage drive in a multi-mode state during the recording of holographic digital data the holographic medium without adverse effects on the strength of the interference patterns formed.

### CROSS-REFERENCE TO RELATED APPLICATIONS

This application makes reference to and claims the benefit of the following co-pending U.S. Provisional Patent Application No. 60/684,531 filed May 26, 2005. The entire disclosure and contents of the foregoing Provisional Application is hereby incorporated by reference. This application also makes reference to the following co-pending U.S. patent applications. The first application is U.S. App. No. [INPH-0007-UT1], entitled “Illuminative Treatment of Holographic Media,” filed May 25, 2006. The second application is U.S. App. No. [INPH-0007-UT2], entitled “Methods and Systems for Laser Mode Stabilization,” filed May 25, 2006. The third application is U.S. App. No. [INPH-0007-UT3], entitled “Phase Conjugate Reconstruction of Hologram,” filed May 25, 2006. The fourth application is U.S. App. No. [INPH-0007-UT4], entitled “Improved Operational Mode Performance of a Holographic Memory System,” filed May 25, 2006. The fifth application is U.S. App. No. [INPH-0007-UT5], entitled “Holographic Drive Head and Component Alignment,” filed May 25, 2006. The sixth application is U.S. App. No. [INPH-0007-UT6], entitled “Optical Delay Line in Holographic Drive,” filed May 25, 2006. The seventh application is U.S. App. No. [INPH-0007-UT7], entitled “Controlling the Transmission Amplitude Profile of a Coherent Light Beam in a Holographic Memory System,” filed May 25, 2006. The eighth application is U.S. App. No. [INPH-0007-UT8], entitled “Sensing Absolute Position of an Encoded Object,” filed May 25, 2006. The ninth application is U.S. App. No. [INPH-0007-UT9], entitled “Sensing Potential Problems in a Holographic Memory System,” filed May 25, 2006. The tenth application is U.S. App. No. [INPH-0007-UT11], entitled “Post-Curing of Holographic Media,” filed May 25, 2006. The eleventh application is U.S. App. No. [INPH-0007-UT12], entitled “Erasing Holographic Media,” filed May 25, 2006. The twelfth application is U.S. App. No. [INPH-0007-UT13], entitled “Laser Mode Stabilization Using an Etalon,” filed May 25, 2006. The thirteenth application is U.S. App. No. [INPH-0007-UT15], entitled “Holographic Drive Head Alignments,” filed May 25, 2006. The fourteenth application is U.S. App. No. [INPH-0007-UT16], entitled “Replacement and Alignment of Laser,” filed May 25, 2006. The entire disclosure and contents of the foregoing U.S. patent applications are hereby incorporated by reference.

### BACKGROUND

1. Field of the Invention

The present invention broadly relates to a holographic data storage drive which records holographic digital data in a holographic recording medium wherein one of the data beam and reference beams paths comprise an optical delay line so that the difference between the optical path lengths of the beams is less than the laser coherence length. The present invention further broadly relates to a method for operating a laser in the holographic data storage drive in a multi-longitudinal mode state during the recording of holographic digital data in the holographic medium without adverse effects on the coherence of the interference patterns formed.

2. Related Art

Developers of information storage devices and methods continue to seek increased storage capacity. As part of this development, holographic memory systems have been suggested as alternatives to conventional memory devices. Holographic memory systems may be designed to record data one bit of information (i.e., bit-wise data storage). See McLeod et al. “Micro-Holographic Multi-Layer Optical Disk Data Storage,” International Symposium on Optical Memory and Optical Data Storage (July 2005). Holographic memory systems may also be designed to record an array of data that may be a 1-dimensional linear array (i.e., a 1×N array, where N is the number linear data bits), or a 2-dimension array commonly referred to as a “page-wise” memory systems. Page-wise memory systems may involve the storage and readout of an entire two-dimensional representation, e.g., a page of data. Typically, recording light passes through a two-dimensional array of low and high transparency areas representing data, and the system stores, in three dimensions, the pages of data holographically as patterns of varying refractive index imprinted into a storage medium. See Psaltis et al., “Holographic Memories,” Scientific American, November 1995, where holographic systems are discussed generally, including page-wise memory systems.

In a holographic data storage system, information is recorded by making changes to the physical (e.g., optical) and chemical characteristics of the holographic storage medium. These changes in the holographic medium take place in response to the local intensity of the recording light. That intensity is modulated by the interference between a data-bearing beam (the data beam) and a non-data-bearing beam (the reference beam). The pattern created by the interference of the data beam and the reference beam forms a hologram which may then be recorded in the holographic medium. If the data-bearing beam is encoded by passing the data beam through, for example, a spatial light modulator (SLM), the hologram(s) may be recorded in the holographic medium as an array of light and dark squares or pixels. The holographic medium or at least the recorded portion thereof with these arrays of light and dark pixels may be subsequently illuminated with a reference beam (sometimes referred to as a reconstruction beam) of the same or similar wavelength, phase, etc., so that the recorded data may be read.

The ability to record and read holograms may be affected by the coherence of the interference pattern at the holographic medium between the data beam and the reference beam. Because the data beam and the reference beam follow different optical paths, there may be an optical path length difference between these two paths before these beams form the interference pattern that is recorded by the holographic medium. This optical path length difference may adversely affect the relative coherence of the interfering beams, and subsequently weaken the interference patterns recorded by the holographic medium, for example, when holographic digital data is recorded, making the recorded hologram difficult to read or unreadable. To avoid such adverse effects the interference pattern that may be caused by optical path length differences between the data beam and reference beam paths, operating constraints may need to be imposed on the holographic data storage system that may make the system less flexible and robust.

Accordingly, what may be needed are ways to: (1) minimize or avoid optical path length differences between data beam and reference beam paths that may adversely affect the strength of the interference patterns recorded by the holographic medium; (2) without needing to impose operating constraints on the holographic data storage system that may make the system less flexible and robust.

### SUMMARY

According to a first broad aspect of the present invention, there is provided a system comprising a holographic data storage drive that records holographic digital data in a holographic recording medium, wherein the holographic data storage drive comprises:
a data beam path having a first optical path length; and
a reference beam path having a second optical path length;
wherein one of the data beam and reference beams paths comprise an optical delay line so that the difference between the first and second optical path lengths is less than the laser coherence length.

According to a second broad aspect of the present invention, there is provided a method comprising the following steps:
(a) providing a holographic data storage drive that records holographic digital data in a holographic recording medium, wherein the holographic data storage drive comprises:
   a multi-mode state capable-laser;
   a data beam path having a first optical path length;
   a reference beam path having a second optical path length;
   wherein one of the data beam and reference beams paths comprise an optical delay line so that the difference between the first and second optical path lengths is less than the laser coherence length; and
(b) operating the laser in a multi-mode state during the recording of holographic digital data the holographic medium.

### BRIEF DESCRIPTION OF THE DRAWINGS

The invention will be described in conjunction with the accompanying drawings, in which:

FIG. 1 is a schematic block diagram of an exemplary holographic data storage drive system;

FIG. 2A is an architectural block diagram of the components of a holographic data storage drive illustrating the optical paths used during a write or record operation, and showing where optical delay lines may be included according to embodiments of the present invention;

FIG. 2B is an architectural block diagram of the components of a holographic data storage drive illustrating the optical paths used during a read or reconstruct operation;

FIG. 3 is a portion of the block diagram of FIG. 2A illustrating potential locations for optical delay lines according to an embodiment of the present invention

FIG. 4 is an architectural block diagram showing one embodiment of an optical delay line which may be used in the holographic data storage drive illustrated in FIG. 3;

FIG. 5 is an architectural block diagram showing another embodiment of an optical delay line which may be used in the holographic data storage drive illustrated in FIG. 3; and

FIG. 6 is an architectural block diagram showing alternative embodiment of the optical delay line shown in FIG. 5.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the term “light source” refers to any source of electromagnetic radiation of any wavelength. The light source of the present invention may be from a laser, one or more laser diodes (LDs), etc. Suitable light sources for use in embodiments of the methods and systems of the present invention include, but are not limited to, those obtained by conventional laser sources, e.g., the blue and green lines of Ar⁺ (458, 488, 514 nm) and He—Cd lasers (442 nm), the green line of frequency doubled YAG lasers (532 nm), and the red lines of He—Ne (633 nm), Kr⁺ lasers (647 and 676 nm), and various LDs (e.g., emitting light having wavelengths of from 290 to 900 nm).

For the purposes of the present invention, the term “laser” refers to conventional lasers, as well as laser (LDs), laser systems based on laser diodes, such as external cavity laser diodes (ECLDs), etc.

For the purposes of the present invention, the term “spatial light intensity” refers to a light intensity distribution or pattern of varying light intensity within a given volume of space.

For the purposes of the present invention, the terms “holographic grating,” “holograph” or “hologram” (collectively and interchangeably referred to hereafter as “hologram”) are used in the conventional sense of referring to an interference pattern formed when a signal or data beam and a reference beam interfere with each other. In cases wherein digital data is recorded page-wise, the signal beam may be encoded with a data modulator, e.g., a spatial light modulator, etc.

For the purposes of the present invention, the term “holographic digital data” refers to a hologram which is a holographic recording of digital data, which may be encoded in multiple ways, such as intensity variation (e.g., a bright spot or area representing a “1” and a dark spot or area representing a “0”), a phase encoding, multi-level representations of digital data, etc.

For the purposes of the present invention, the term “holographic recording” refers to the act of recording a hologram in a holographic recording medium. The holographic recording may provide bit-wise storage (i.e., recording of one bit of data), may provide storage of a 1-dimensional linear array of data (i.e., a 1×N array, where N is the number linear data bits), or may provide 2-dimensional storage of a page of data.

For the purposes of the present invention, the term “holographic storage medium” refers to a component, material, etc., that is capable of recording and storing, in three dimensions (i.e., the X, Y and Z dimensions), one or more holograms (e.g., bit-wise, linear array-wise or page-wise) as one or more patterns of varying refractive index imprinted into the medium. Examples of holographic media useful herein include, but are not limited to, those described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), issued Aug. 24, 2004; U.S. Patent Application No. 2003-0206320, published Nov. 6, 2003, (Cole et al), and U.S. Patent Application No. 2004-0027625, published Feb. 12, 2004, the entire contents and disclosures of which are herein incorporated by reference.

For the purposes of the present invention, the term “data page” or “page” refers to the conventional meaning of data page as used with respect to holography. For example, a data page may be a page of data, one or more pictures, etc., to be recorded or recorded in a holographic medium.

For the purposes of the present invention, the term “recording light” refers to a light source used to record information, data, etc., into a holographic recording medium.

For the purposes of the present invention, the term “recording data” refers to storing or writing holographic data in a holographic medium.

For the purposes of the present invention, the term “reading data” refers to retrieving, recovering, or reconstructing holographic data stored in a holographic medium.

For the purposes of the present invention, the term “data modulator” refers to any device that is capable of optically representing data in one or two-dimensions from a signal beam.

For the purposes of the present invention, the term “spatial light modulator” refers to a data modulator device that is an electronically controlled, active optical element.

For the purposes of the present invention, the term “refractive index profile” refers to a two-dimensional (X, Y) mapping of the refractive index pattern recorded in a holographic recording medium.

For the purposes of the present invention, the term “data beam” refers to a recording beam containing a data signal. As used herein, the term “data modulated beam” refers to a data beam that has been modulated by a modulator such as a spatial light modulator (SLM). The reference and data beams may be created by splitting a single beam from the laser (for example, by using a beam splitter). After splitting, the reference and data beams subsequently interfere and record holographic data within the holographic storage medium.

For the purposes of the present invention, the term “optical element” refers to any component or plurality of components that affect the phase or intensity of the light, including, but not limited to, the spatial location of the light, the angle of the light, etc. Optical elements may include mirrors, lenses, apertures, phasemasks, etc.

For the purposes of the present invention, the term “optical delay line” refers to any component or plurality of components that increase or lengthen the optical path length. Components that may be used as optical delay lines include corner cube prisms, a plurality (e.g., pair of) of mirrors, solid blocks of glass or other optical materials, etc.

For the purposes of the present invention, the term “optical delay path” refers to the additional optical path length created by use of the optical delay line.

For the purposes of the present invention, the term “holographic data storage drive” refers to the assembly of components which record holographic data to a holographic medium and/or read holographic data from a holographic medium. The holographic data storage drive may include light sources (e.g., lasers or laser diodes), optical elements (e.g., lenses, prisms, mirrors, beam splitters, filters, waveplates, etc.), data modulators (e.g., SLM), detectors (e.g., cameras), etc.

For the purposes of the present invention, the terms “laser coherence length” and “coherence length of the laser” refer to a measure of the spectral bandwidth of the laser. The coherence length is related to the tolerable path length difference between the reference and data beams by the fact that a larger bandwidth has a larger spectral width, and equivalently a shorter coherence length. A shorter coherence length results in a shorter tolerable optical path length difference between the reference and data beams, which may manifest itself as a weaker and weaker interference pattern, and hence a weaker hologram strength, until the hologram strength reaches or approaches zero (no hologram) when the path difference is equal to the coherence length.

For the purposes of the present invention, the term “optical path length” refers to the length of a path as measured by the number of wavelengths of light in that length, or an equivalent physical path length in air. Optical path length is different from the physical path length in that the wavelength of light may shorten within optical materials other than air (for example, in glass with refractive index 1.5, the wavelength inside this glass will be 1/1.5 times that in air). In other words, the effective optical path length is generally longer than the physical path length. From the standpoint of coherence length, the optical path length is the most relevant.

For the purposes of the present invention, the term “path length difference” refers to the propagation difference between two optical path lengths.

For the purposes of the present invention, the term “mode” refers to the longitudinal mode operation of a laser.

For the purposes of the present invention, the term “single-mode” refers to a light beam comprising a single wavelength of light.

For the purposes of the present invention, the term “multi-mode” refers to a light beam comprising more than one wavelength of light.

Description of Holographic Data Storage Drive System Generally

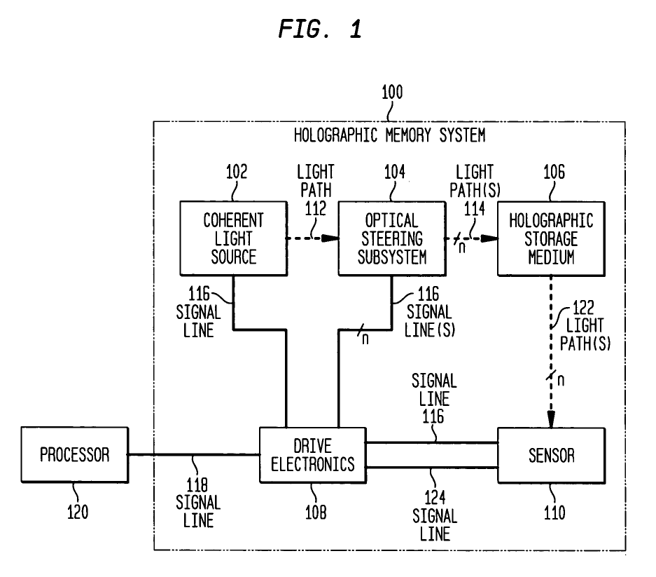

FIG. 1 is a block diagram of an exemplary holographic data storage (HDS) drive system in which embodiments of the present invention may be used. Although embodiments of the present invention may be described in the context of the exemplary holographic system shown in FIG. 1, the present invention may also be implemented in connection with any system now or later developed that implements holographics.

Holographic memory system 100 (“HMS 100” herein) receives along signal line 118 signals transmitted by an external processor 120 to read and write data to a photosensitive holographic storage medium 106. As shown in FIG. 1 processor 120 communicates with drive electronics 108 of HMS 100. Processor 120 transmits signals based on the desired mode of operation of HMS 100. For ease of description, the present invention will be described with reference to read and write operations of a holographic system. However, that the present invention may be applied to other operational modes of a holographic system, such as Pre-Cure, Post-Cure, Write Verify, or any other operational mode implemented now or in the future in an holographic system.

Using control and data information from processor 120, drive electronics 108 transmit signals along signal lines 116 to various components of HMS 100. One such component that may receive signals from drive electronics 108 is coherent light source 102. Coherent light source 102 may be any light source known or used in the art that produces a coherent light beam. In one embodiment, coherent light source 102 may be a laser.

The coherent light beam from coherent light source 102 is directed along light path 112 into an optical steering subsystem 104. Optical steering subsystem 104 directs one or more coherent light beams along one or more light paths 114 to holographic storage medium 106. In the write operational mode described further below at least two coherent light beams are transmitted along light paths 114 to create an interference pattern in holographic storage medium 106. The interference pattern induces alterations in storage medium 106 to form a hologram.

In the read operational mode, holographically-stored data is retrieved from holographic storage medium 106 by projecting a reconstruction or probe beam along light path 114 into storage medium 106. The hologram and the reconstruction beam interact to reconstruct the data beam which is transmitted along light path 122. The reconstructed data beam may be detected by a sensor 110. Sensor 110 may be any type of detector known or used in the art. In one embodiment, sensor 110 may be a camera. In another embodiment, sensor 110 may be a photodetector.

The light detected at sensor array 110 is converted to a signal and transmitted to drive electronics 108 via signal line 124. Processor 120 then receives the requested data or related information from drive electronics 108 via signal line 118.

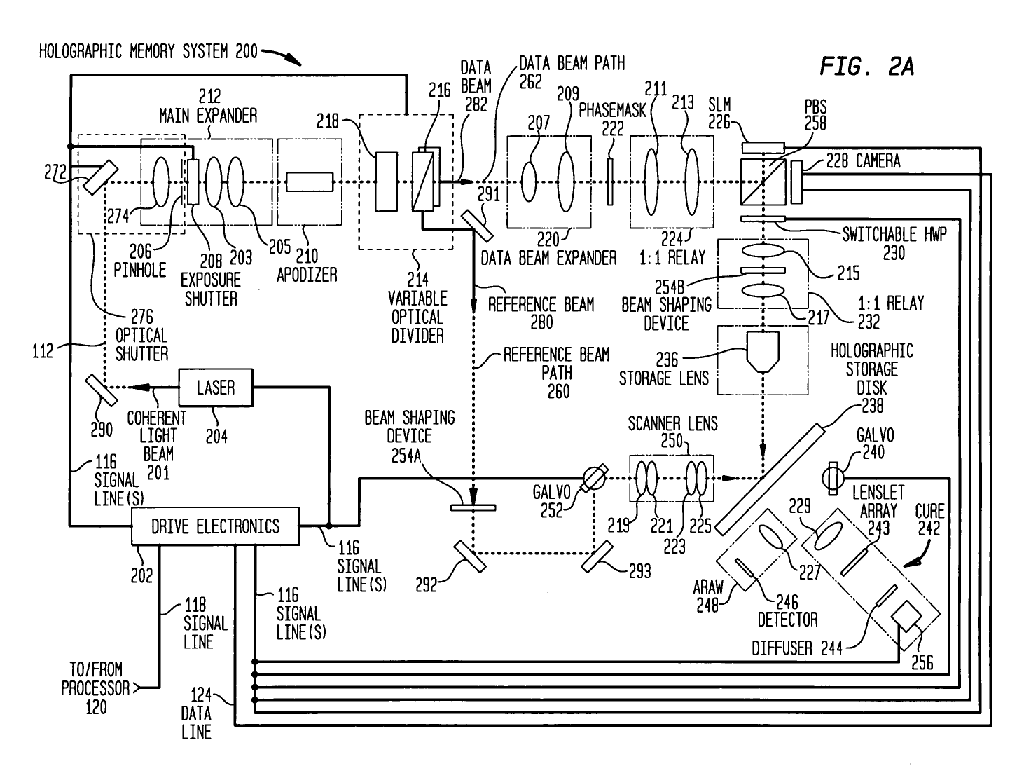

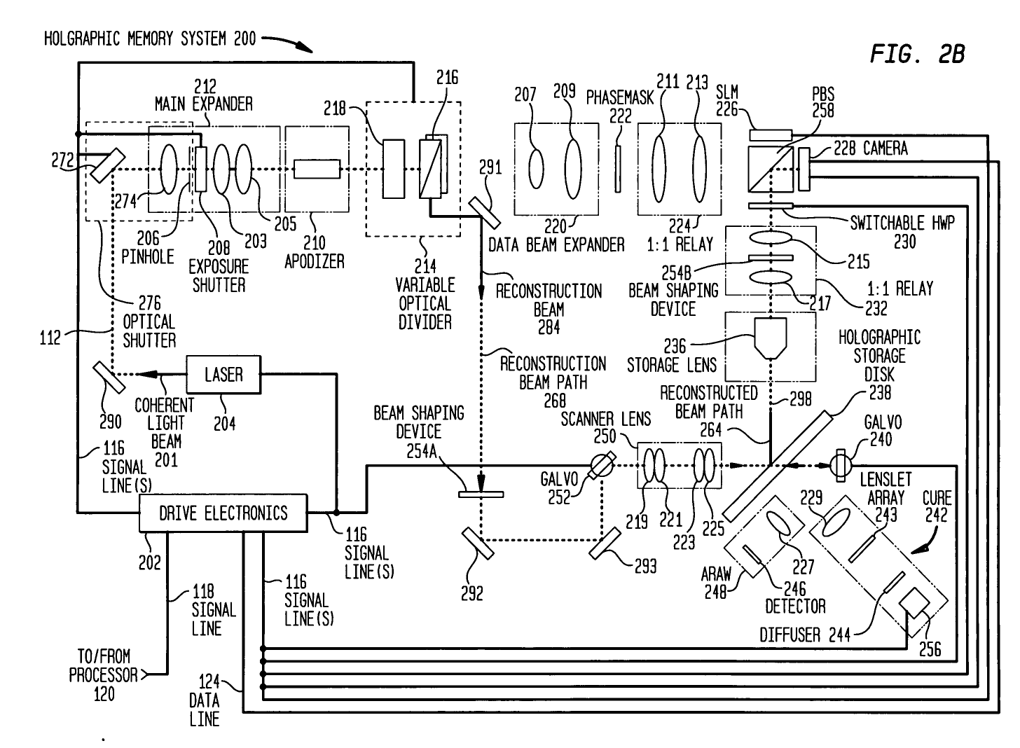

The components of an exemplary embodiment of HMS 100 are illustrated in more detail in FIGS. 2A and 2B, and is referred to generally as holographic memory system 200 (“HMS 200” herein). FIGS. 2A and 2B are similar schematic block diagrams of the components of one embodiment of HMS 200 illustrating the optical paths utilized during write and read operations, respectively.

Referring first to FIG. 2A, HMS 200 is shown in a record or write operation or mode (herein “write mode configuration”). Coherent light source 102 (see FIG. 1) is shown in FIG. 2A in the form of laser 204. Laser 204 receives via signal line 116 control signals from an embodiment of drive electronics 108 (FIG. 1), referred to in FIG. 2A as drive electronics 202. In the illustrated write mode configuration, such a control signal may cause laser 204 to generate a coherent light beam 201 which is directed along light path 112 (see FIG. 1).

Coherent light beam 201 from laser 204 is reflected by mirror 290 and may be directed through optical shutter 276. Optical shutter 276 comprises beam deviation assembly 272, focusing lens 274 and pinhole 206 that collectively shutter coherent light beam 201 from entering the remainder of optical steering subsystem 104. The details of the exemplary optical shutter 276 are described in more detail in the above-related U.S. App. No. [[INPH-0007-UT4], entitled “Improved Operational Mode Performance of a Holographic Data Storage (HDS) Drive System,” filed ______. Further, it should be noted that this is but one exemplary optical shutter and other embodiments may use a different type of optical shutter or an optical shutter need not be used.

Coherent light beam 201 passing through optical shutter 276 enters main expander assembly 212. Main expander assembly 212 includes lenses 203 and 205 to expand coherent light beam 201 to a fixed diameter and to spatially filter coherent light beam 201. Main expander assembly 212 also includes lens 274 and pinhole 206 to spatially filter the light beam. An exposure shutter 208 within main expander assembly 212 is an electromechanical device which may be used to control recording exposure times.

Upon exiting main expander assembly 212, the coherent light beam 201 may be directed through apodizer 210. Light emitted from a laser such as laser 204 may have a spatially varying distribution of light. Apodizer 210 converts this spatially varying intensity beam 201 from laser 204 into a more uniform beam with controlled edge profiles.

After passing through apodizer 210, coherent light beam 201 may enter variable optical divider 214. Variable optical divider 214 uses a dynamically-controlled polarization device 218 and at least one polarizing beam splitter (PBS) 216 to redirect coherent light beam 201 into one or more discrete light beams transmitted along two light paths 114 (see FIG. 1), referred to in FIG. 2A as light path 260 and light path 262. Variable optical divider 214 dynamically allocates power of coherent light beam 201 among these discrete light beams, indicated as 280 and 282. In the write operational mode shown in FIG. 2A, the discrete light beam directed along light path 260 is referred to as reference light beam 280 (also referred to herein as reference beam 280), while the discrete light beam directed along light path 262 is referred to as data light beam 282 (also referred to herein as data beam 282).

Upon exiting variable optical divider 214, reference beam 280 is reflected by mirror 291 and directed through a beam shaping device 254A. After passing through beam shaping device 254A, reference beam 280 is reflected by mirrors 292 and 293 towards galvo mirror 252. Galvo mirror 252 reflects reference beam 280 into scanner lens assembly 250. Scanner lens assembly 250 has lenses 219, 221, 223 and 225 to pivotally direct reference beam 280 at holographic storage medium 106, shown in FIG. 2A as holographic storage disk 238.

Referring again to variable optical divider 214, data light beam 282 exits variable optical divider 214 and passes through data beam expander lens assembly 220. Data beam expander 220 implements lenses 207 and 209 to magnify data beam 282 to a diameter suitable for illuminating Spatial Light Modulator (SLM) 226, located further along data beam path 262. Data beam 282 then passes through phasemask 222 to improve the uniformity of the Fourier transform intensity distribution. Data beam 282 illumination of phasemask 222 is then imaged onto SLM 226 via 1:1 relay 224 having lenses 211 and 213. PBS 258 directs data beam 282 onto SLM 226.

SLM 226 modulates data beam 282 to encode information into data beam 282. SLM 226 receives the encoding information from drive electronics 202 via a signal line 116. Modulated data beam 282 is reflected from SLM 226 and passes through PBS 258 to a switchable half-wave plate 230. Switchable half-wave plate 230 may be used to optionally rotate the polarization of data beam 282 by 90 degrees. A 1:1 relay 232 containing a beam-shaping device 254B and lenses 215 and 217 directs data beam 282 to storage lens 236 which produces a filtered Fourier transform of the SLM data inside holographic storage disk 238. At a particular point within holographic storage disk 238, reference light beam 280 and data light beam 282 create an interference pattern to record a hologram in holographic storage disk 238.

Referring next to the read mode configuration illustrated in FIG. 2B, laser 204 generates coherent light 201 in response to control signals received from drive electronics 202. As noted with regard to FIG. 2A, coherent light beam 201 is reflected by mirror 290 through optical shutter 276 that shutters coherent light beam 201 from entering the remainder of optical steering subsystem 104. Coherent light beam 201 thereafter enters main expander assembly 212 which expands and spatially filters the light beam, as described above with reference to FIG. 2A. Upon exiting main expander assembly 212, coherent light beam 201 is directed through apodizer 210 to convert the spatially varying intensity beam into a more uniform beam.

In the arrangement of FIG. 2B, when coherent light beam 201 enters variable optical divider 214, dynamically-controlled polarization device 218 and PBS 216 collectively redirect the coherent light into one discrete light beam 114, referred to as reconstruction beam 284. Reconstruction beam 284 travels along reconstruction beam path 268, which is the same path 260 traveled by reference beam 280 during the write mode of operation, as described with reference to FIG. 2A.

A desired portion of the power of coherent light beam 201 is allocated to this single discrete reconstruction beam 284 based on the selected polarization implemented in device 218. In certain embodiments, all of the power of coherent light beam 201 is allocated to reconstruction light beam 284 to maximize the speed at which data may be read from holographic storage disk 238.

Upon exiting variable optical divider 214, reconstruction beam 284 is reflected from mirror 291. Mirror 291 directs reconstruction beam 284 through beam shaping device 254A. After passing through beam shaping device 254A, reconstruction beam 284 is directed to scanner lens assembly 250 by mirrors 292 and 293, and galvo 252. Scanner lens assembly 250 pivots reconstruction beam 284 at a desired angle toward holographic storage disk 238.

During the read mode, reconstruction beam 284 may pass through holographic storage disk 238 and may be retro-reflected back through the medium by a second conjugator galvo 240. As shown in FIG. 2B, the data reconstructed on this second pass through storage disk 238 is directed along reconstructed data beam path 298 as reconstructed data beam 264.

Reconstructed data beam 264 passes through storage lens 236 and 1:1 relay 232 to switchable half wave plate 230. Switchable half wave plate 230 is controlled by drive electronics 202 so as to have a negligible polarization effect. Reconstructed data beam 264 then travels through switchable half wave plate 230 to PBS 258, all of which are described above with reference to FIG. 2A. PBS 258 reflects reconstructed data beam 264 to an embodiment of sensor 110 (see FIG. 1) in the form of a camera 228. The light detected by camera 228 is converted to a signal and transmitted to drive electronics 202 via signal line 124 (see FIG. 1). Processor 120 then receives the requested data and/or related information from drive electronics 202 via signal line 118 (see FIG. 1).

HMS 200 may further comprise an illuminative media cure subsystem 242. Media cure subsystem 242 is configured to provide a uniform curing beam with reduced coherence to storage disk 238 to pre-cure and/or post-cure a region of storage disk 238 following the writing process. Media cure subsystem 242 may comprise a laser 256 sequentially aligned with a diffuser 244, a lenslet array 243 and a lens 229. The light from laser 256 is processed by diffuser 244, lenslet array 243, and lens 229 to provide a uniform curing beam with reduced coherence prior to reaching storage disk 238.

HMS 200 may additionally comprise an associative read after write (ARAW) subsystem 248. ARAW subsystem 248 is configured to partially verify a hologram soon after the hologram is written to holographic storage disk 238. ARAW subsystem may comprise a lens 227 and a detector 246. Holographic system 100 uses ARAW subsystem 248 by illuminating a written hologram with an all-white data page. When a hologram is illuminated by this all-white data page, ARAW subsystem 248 detects the reconstructed reference beam resulting from this all-white illumination. Specifically, detector 246 examines the reconstructed reference beam to verify that the hologram has been recorded correctly.

Description of Using Optical Delay Line in Holographic Data Storage Drive

Embodiments of the system and method of the present invention are based on the discovery that optical path length differences between the between data beam and reference beam paths that may adversely affect the strength of interference patterns recorded by the holographic medium, especially holographic digital data, may be minimized or avoided, but without having to impose operating constraints on the holographic drive that may make the drive less flexible and robust. For example, while the data beam and reference beam are often generated or derived from the same laser source (e.g., through the use of an optical divider such as a beam splitter), the optical paths, and especially the path length of the data beam and reference beam may differ between the beam splitter and the holographic medium for a variety of reasons. These reasons may include the number and types of optical elements present in each of the respective optical paths, spacing and placement constraints imposed by the holographic data storage drive environment, etc. If the difference between the path length of the data and reference beams approaches the laser coherence length, adverse effects on the strength of the interference patterns may occur that may result in the recording of holographic digital data by the holographic medium that is either difficult to read or is unreadable. This difficulty in reading the holographic digital data is due to weaker (i.e., lower amplitude) interference patterns which form weaker holograms. In trying to read the recorded holographic data, the resulting signal which is generated is also weaker, and thus the signal to noise ratio (SNR), which is a strong indicator of the recoverability of holographic digital data, may undesirably drop.

These adverse effects on strength of the interference pattern may be overcome by maximizing the laser coherence length. Maximization of laser coherence length may be achieved by having the laser generating the data and reference beams operate in a single-mode state, versus a multi-mode state. But having a laser that generates the object and reference beams function strictly in a single-mode state may impose a significant operating constraint on the holographic data storage drive that records and reads the holographic data, especially holographic digital data. For example, operating in a single-mode state may be difficult to achieve with some lasers, such as external cavity diode lasers, or may otherwise reduce the flexibility of operation and robustness of the holographic data storage drive system.

Instead, the embodiments of the system and method of the present invention solve the problem of potential optical path length differences between the object beam and the reference beam by including in one of the data beam and reference beams paths an optical delay line so that the difference between the respective optical path lengths is less than the laser coherence length. In essence, the optical delay line “optically lengthens” the shorter of the two optical paths and thus reduces the differences in optical path length between the two optical paths to less than the laser coherence length. This difference in optical path lengths may be reduced by the optical delay line to as small a difference as is possible or practicable, including a path length difference that equals or approaches zero, e.g., no path length difference. By reducing the differences in optical path length between the data beam and reference beam paths to less than the laser coherence length, the laser generating the data beam and reference beam paths may operate not only in a single-mode state, but also in a multi-mode state without causing adverse strength effects on the interference pattern recorded by the holographic medium. This ability to operate in a multi-mode state may also relax the operating constraints on the holographic data storage drive.

Referring again to FIG. 2A by way of illustration, reference beam path 260 may be shorter (or longer) than the data beam path 262 in HMS system 200. If reference beam path 260 is shorter than data beam path 262, and if the difference in optical path length between reference beam path 260 and data beam path 262 is greater than the laser coherence length of laser 204, adverse effects on the strength of the interference patterns of the holographic digital data recorded by holographic storage disk 238 may occur. To remedy this difference in optical path length, an optical delay line (ODL) may be inserted into reference beam path 260 to “optically lengthen” path 260 so that the difference in the optical path length between reference beam path 260 and data beam path 262 is less than the laser coherence length for laser 204. Conversely, if object beam path 262 were shorter than reference beam path 260, and if the difference in optical path length between data beam path 262 and reference beam path 260 were greater than the laser coherence length of laser 204, adverse effects on the coherence of the interference patterns and holographic digital data recorded by holographic storage disk 238 may also occur. To remedy this difference in optical path length, an optical delay line (ODL) may instead be inserted into data beam path 262 to “optically lengthen” path 262 so that the difference in the optical path length between data beam path 262 and reference beam path 260 is less than the laser coherence length for laser 204.

In some embodiments, one optical delay line may be inserted into the shorter of reference beam path 260 or data beam path 262 to “optically lengthen” the shorter path. In other embodiments, a plurality of optical delay lines may be inserted into the shorter path either in the same position or in different positions in the shorted path. The optical delay line or lines may impart a fixed degree of “optical lengthening,” i.e., the optical delay line or lines provide a non-variable or set amount of “optical lengthening.” Alternatively, the optical delay line or lines may impart a degree of “optical lengthening” that is variable, i.e., the optical delay line or lines may be adjusted to provide differing degrees of “optical lengthening.” The optical delay line or lines may be permanently inserted within the shorter of the reference beam path 260 or data beam path 262, or may be removable from the optical path when the holographic data storage drive is operating or in a mode that does not involve multiple optical paths, e.g., reading or reconstructing holographic data as illustrated in HMS 200 system 200 of FIG. 2B.

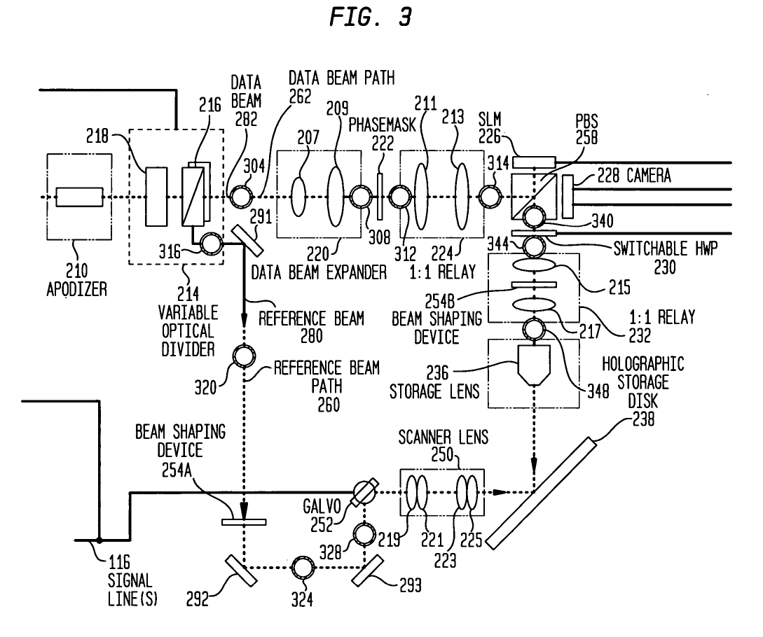

The potential insertion points for ODLs in, for example, HMS system 200, is illustrated in FIG. 3 which shows the reference beam path 260 and data beam path 262 of HMS 200 from FIG. 2A. Points or positions where ODLs may be inserted in reference beam path 260 or in data beam path 262 are indicated by circles 304 through 348. Circles 304 through 328 represent more optimal placement positions for the ODLs, while circles 340 through 348 represent potential but less optimal placement positions for the ODLs. As illustrated in FIG. 3, optimal placement positions for ODLs in data beam path 262 include positions between variable optical divider 214 (e.g., including a beam splitter such as polarizing beam splitter (PBS) 216) and PBS 258, for example, between variable optical divider 214 and data beam expander 220 (304), between data beam expander 220 and phasemask 222 (308), between phasemask 222 and relay 224 (312), and between relay 224 and PBS 258 (314). As also illustrated in FIG. 3, optimal placement positions for ODLs in reference beam path 260 include positions between variable optical divider 214 and scanner lens assembly 250, for example, between variable optical divider 214 and mirror 291 (316), between mirrors 291 and 292 (320), between mirrors 292 and 293 (324), or between mirror 293 and galvo mirror 252 (328). Potential but less optimal placement positions for ODLs in data beam path 262 include positions between PBS 258 and storage lens 236, for example, between PBS 258 and switchable waveplate 230 (340), between switchable waveplate 230 and relay 232 (344), or between relay 232 and storage lens 236 (348). While one such ODL may be inserted at one of these positions 316 through 328 in reference beam path 260 or one of these positions 304 through 312 (or 340 through 348) in data beam path 262 to “optically lengthen” paths 260 or 262, ODLs may be inserted at more than one such position or a plurality of ODLs may be inserted or used in one such position. In addition, while circles 304 through 348 show for illustrative purposes the ODLs as being between midway between pairs of components/assemblies in the optical path, the ODLs may be positioned at any point along the optical path between the pairs of components/assemblies.

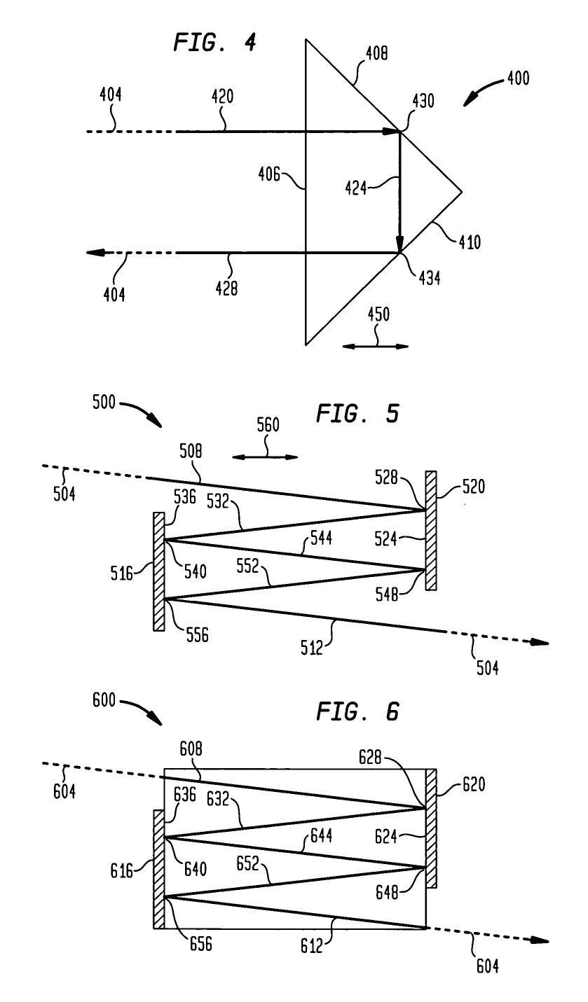

One embodiment of an optical delay line which may be used in, for example, positions 304 through 348 is shown in FIG. 4, in the form of a right angle prism, indicated generally as 400, which is inserted into or positioned within an optical path, which is indicated generally by a dashed line as 404. Prism 400 comprises three faces indicated as 406, 408 and 410. The optical delay path 416 created by prism 400 comprises a first delay path segment 420, a second delay path segment 424 which is perpendicular to segment 420 and a third delay path segment 428 which is perpendicular to segment 424 and parallel to segment 420. As shown in FIG. 4, a light beam from optical path 404 initially follows optical delay path 416 along first segment 420, passing through face 406 of prism 400. When the light beam moving along first segment 420 reaches face 408 at point 430, the light beam is reflected along second path segment 424 at a right angle to first path segment 420. The light beam then moves along second path segment 424 until reaching face 410, where the light beam is again reflected at point 434 along third path segment 428 at a right angle to second path segment 424. The degree to which the optical path 404 has been lengthened is determined by the sum of segments 420, 424 and 428 comprising optical delay path 416. As indicated by double headed arrow 450, prism 400 may be moved, for example, parallel to first and second path segments 420 and 428 to adjust the length of optical delay path 416 (i.e., either shorten or lengthen parallel segments 420 and 428 of optical delay path 416). In an alternative embodiment, prism 400 may be replaced by a right angle corner cube mirror.

Another embodiment of an optical delay line which may be used in, for example, positions 304 through 348, is shown in shown in FIG. 5, which is indicated generally as 500, and which is inserted into or positioned within an optical path, indicated generally as dashed line 504, and having an entering segment indicated by solid line 508, and an exiting segment indicated by solid line 512. Optical delay line (ODL) 500 comprises a pair of axially spaced apart and opposed adjustable mirrors, indicated as 516 and 520. As shown in FIG. 5, mirrors 508 and 512 may be offset relative to each other to permit a light beam to enter ODL 500 along entering segment 508. As further shown in FIG. 5, the light beam moves along entering segment 508 at an angle and reaches reflecting surface 524 of mirror 520 at point 528. The light beam is reflected at an angle from surface 524 along segment 532 until reaching reflecting surface 536 of mirror 516 at point 540. The light beam is then reflected by surface 536 at an angle along segment 544 until again reaching surface 524 of mirror 520 at point 548. The light beam is then reflected by surface 524 again at angle along segment 552 until again reaching surface 536 at point 556. The light beam is then reflected again by surface 536 at an angle along exiting segment 512 of optical path 504. As can be seen in FIG. 5, the optical delay path for ODL 500 is represented by the total sum of one of segments 508 or 512, with segments 532, 544 and 552; the number of such segments 532, 544 and 552 in FIG. 5 is merely representative in that fewer or greater number of segments may comprise the optical delay path depending upon the degree of optical path lengthening required for optical path 504. As indicated by double headed arrow 560, the distance between faces 524 and 536 of mirrors 516 and 520 may also be adjusted to change the length of the optical delay path of ODL 500.

An alternative embodiment to ODL 500 is illustrated in FIG. 6, which is indicated generally as 600 in the form of a fixed glass block optical delay line and which is inserted into or positioned within an optical path, indicated generally as dashed line 604, having an entering segment indicated by solid line 608, and an exiting segment indicated by solid line 612. As shown in FIG. 6, block 600 comprises a pair of axially spaced apart and opposed reflecting surfaces, for example, in the form of external reflective mirror coatings, indicated as 616 and 620. Like mirrors 516 and 520 of ODL 500, as shown in FIG. 6, the reflective mirror coatings 616 and 620 are offset relative to each other to permit a light beam to enter block 600 along entering segment 608. As further shown in FIG. 6, the light beam moves along segment 608 at an angle and reaches reflecting surface 624 of coating 620 at point 628. The light beam is reflected from surface 624 at an angle along segment 632 until reaching reflecting surface 636 of coating 616 at point 640. The light beam is then reflected by surface 636 along segment 644 until again reaching surface 624 of coating 616 at point 648. The light beam is then reflected by surface 624 again at an angle along segment 652 until again reaching surface 636 of coating 616 at point 656. The light beam is then reflected again by surface 636 along exiting segment 612 of optical path 604. As can be seen in FIG. 6, the optical delay path for block 600 is represented by the total sum of one of segments 608 or 612, with segments 632, 644 and 652; again the number of such segments 632, 644 and 652 in FIG. 5 is merely representative in that fewer or greater number of segments may comprise the optical delay path depending upon the degree of optical path lengthening required for optical path 504. Because the distance between surfaces 620 and 632 is essentially fixed, the optical delay path of block 600 is also essentially fixed.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A system comprising a holographic data storage drive that records holographic digital data in a holographic recording medium, wherein the holographic data storage drive comprises:
a data beam path having a first optical path length; and
a reference beam path having a second optical path length;
wherein one of the data beam and reference beams paths comprise an optical delay line so that the difference between the first and second optical path lengths is less than the laser coherence length.

2. The system of claim 1, wherein the holographic data storage drive comprises a multi-mode state capable-laser.

3. The system of claim 2, wherein the laser comprises an external cavity diode laser.

4. The system of claim 1, wherein one of the data beam and reference beams paths comprise a plurality of optical delay lines.

5. The system of claim 1, wherein the optical delay lines are inserted in more than one position in one of the data beam and reference beams paths.

6. The system of claim 1, wherein the reference beam path comprises the optical delay line.

7. The system of claim 6, wherein the optical delay line is positioned in the reference beam path between an optical divider and a scanner lens assembly.

8. The system of claim 7, wherein the optical delay in is positioned between a pair of mirrors in the reference beam path.

9. The system of claim 1, wherein the data beam path comprises the optical delay line.

10. The system of claim 9, wherein the optical delay line is positioned in the data beam path between an optical divider and a beam splitter adjacent a spatial light modulator.

11. The system of claim 10, wherein the optical delay line is positioned between the optical divider and a data beam expander.

12. The system of claim 9, wherein the optical delay line is positioned in the data beam path between beam splitter adjacent a spatial light modulator and a storage lens.

13. The system of claim 1, wherein the optical delay line comprises a right angle prism or right angle corner cube mirror.

14. The system of claim 13, wherein the optical delay line defines an optical delay path and wherein prism or mirror is movable to adjust the length of optical delay path.

15. The system of claim 1, wherein the optical delay line comprises a pair of opposing axially spaced apart reflecting surfaces.

16. The system of claim 15, wherein the optical delay line defines an optical delay path and wherein the distance between the reflecting surfaces is adjustable to adjust the length of optical delay path.

17. The system of claim 16, wherein the pair of reflecting surfaces comprise a pair of mirrors.

18. The system of claim 15, wherein the distance between the reflecting surfaces is fixed.

19. The system of claim 18, wherein the optical delay line comprises a fixed glass block and wherein the pair of reflecting surfaces comprise a pair of axially spaced apart external reflective mirror coatings of the glass block.

20. A method comprising the following steps:
(a) providing a holographic data storage drive that records holographic digital data in a holographic recording medium, wherein the holographic data storage drive comprises:
a multi-mode state capable-laser;
a data beam path having a first optical path length;
a reference beam path having a second optical path length;
wherein one of the data beam and reference beams paths comprise an optical delay line so that the difference between the first and second optical path lengths is less than the laser coherence length; and
(b) operating the laser in a multi-mode state during the recording of holographic digital data the holographic medium;

21. The method of claim 20, wherein step (a) comprises positioning an optical delay line in the reference beam path.

22. The method of claim 20, wherein step (a) comprises positioning an optical delay line in the data beam path.

23. The method of claim 20, wherein step (a) comprises positioning an optical delay line having an adjustable optical delay path.

24. The method of claim 20, wherein step (a) comprises positioning a removable optical delay line.

25. The method of claim 20, wherein step (a) comprises providing a holographic data storage drive comprising an external cavity diode laser.
